(19) United States
(12) Patent Application Publication
(10) Pub. No.: US 2025/0348360 A1
(43) Pub. Date: Nov. 13, 2025

(54) AUTOMATED WORKFLOW CREATION

(71) Applicant: Microsoft Technology Licensing, LLC, Redmond, WA (US)

(72) Inventors: Eden ABADI, Dvir (IL); Gal BERGER, Herzelia (IL); Michal SHECHTER NACHMANY, Hod Hasharon (IL); Hani Hana NEUVIRTH, Tel Aviv (IL)

(21) Appl. No.: 18/663,033

(22) Filed: May 13, 2024

(51) Int. Cl. G06F 9/50

(52) U.S. Cl. CPC G06F 9/5027

(57) ABSTRACT

A computer-implemented method generates workflow definitions in workflow definition language using one or more large language models, LLMs. The method includes receiving a natural language description of an automated workflow and generating a plan generation prompt including the natural language description and plan generation instructions. The plan generation prompt is input to one of the LLMs and in response a structured plan comprising a plurality of actions are received. For each action, a corresponding segment of workflow definition language is generated to provide a plurality of segments of workflow definition language. The segments are combined to form a workflow definition corresponding to the natural language description.

### BACKGROUND

Automated workflows may be used in computing environments (e.g. cloud computing environments) to provide connection and integration between different apps, data services and systems. For example, automated workflows can be employed in a cybersecurity setting, where a workflow may be used to define a security playbook, the security playbook being a list of required steps that should be followed in response to an incident or security threat.

The automated workflows comprise a series of actions to be executed in response to an initial trigger action. An example trigger may be the occurrence of a pre-determined event (e.g. a security alert or incident), a scheduled start time or in response to a user request.

The workflow is defined in a suitable workflow definition language, according to a predefined schema. For example, Microsoft® Azure Logic Apps uses JSON (JavaScript Object Notation) as the basis of its workflow definitions. Writing workflow definitions in the definition language requires programming skills, which experts in the relevant domain (e.g. security analysts) may not possess.

Accordingly, GUI-based tools are available for constructing workflows that do not require programming skills. These tools allow the user to add new actions into the workflow and connect them in sequence. However, constructing a workflow can still be a daunting and time-intensive task for a novice user. In addition, ill-defined workflows can be unnecessarily complex or erroneous, and as such consume unnecessary computing resources such as storage, CPU resource or result in unnecessary network connections.

### SUMMARY

According to one aspect of the disclosure, there is provided a computer-implemented method of generating workflow definitions in workflow definition language, the method employing at least one large language model, LLM, the method comprising: receiving a natural language description of an automated workflow; generating a plan generation prompt including the natural language description and plan generation instructions; providing the plan generation prompt as input to the at least one LLM, and receiving in response a structured plan comprising a plurality of actions; generating a plurality of segments of workflow definition language by generating, for each action in the plurality of actions, a corresponding segment of workflow definition language; and generating a workflow definition corresponding to the natural language description by combining the plurality of segments of workflow definition language.

According to another aspect of the disclosure there is provided a computer-implemented method of generating a shot data store for use in generation of automated workflows in workflow definition language from natural language, comprising: receiving a workflow definition in a workflow definition language and a user description of the workflow definition; generating, from the workflow definition, a structured plan comprising a plurality of actions corresponding to the workflow definition; generating, from the structured plan, a natural language description of the workflow definition; storing the workflow definition, the structured plan, the natural language description and the user description in a shot data store.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of an example environment including a system according to the disclosure.

FIG. 2 is an example workflow definition.

FIG. 3 is a schematic block diagram of example logic for generating a workflow based on a natural language description.

FIG. 4 is a schematic illustration of a shot data store according to the disclosure.

FIGS. 5A-C respectively illustrate a corresponding first natural language description, second natural language description and plan.

FIG. 6 is a flowchart illustrating an example method of populating a shot data store in accordance with the disclosure herein.

FIG. 7 is a flowchart illustrating an example of the functionality of the rephrasing component of FIG. 3.

FIG. 8 is a flowchart illustrating a further example of the functionality of the rephrasing component of FIG. 3.

FIG. 9 is a flowchart illustrating an example of the functionality of the trigger classifier of FIG. 3.

FIG. 10 is a flowchart illustrating an example of the functionality of the plan generator of FIG. 3.

FIG. 11 is a flowchart illustrating an example of the functionality of the workflow generator of FIG. 3

FIGS. 12A-E respectively illustrate example user interfaces according to the disclosure.

FIGS. 13A-D are graphs illustrating the performance of example systems.

FIG. 14 is a block diagram of an example computing system.

### DETAILED DESCRIPTION

In overview, examples of the disclosure provide techniques for generating workflow definitions in a workflow definition language based on a natural language description of the workflow. The techniques make use of generative large language models (LLMs) to generate the workflow definition. The examples involve generating a list of actions (also referred to herein as a “plan”) in a pseudocode form from a natural language description. A segment of workflow definition language may then be generated from each action in the list, which are combined to form the workflow definition language corresponding to the initial description. These steps of generating an intermediate representation in a structured pseudocode plan, where each action in the pseudocode corresponds to a segment of the workflow definition language to be generated, provides a means of accurately generating workflow definition language, thus resulting in a more accurate workflow that reflects the user's intention. This provides a convenient means of allowing users without programming skills to generate workflows, and is less time consuming and requires less skill than using GUI-based tools. In some examples, it also results in more computationally efficient workflows than those created by users relying on inadequate programming skills or incomplete knowledge, thus reducing processor and memory usage, and minimizing unnecessary network communications.

In some examples, the natural language description is a rephrased version of an initial description provided by the user. The use of rephrased descriptions ensures that the natural language description includes sufficient detail to infer a comprehensive and accurate action list. In some examples, the trigger action of the workflow is also inferred from the natural language description.

As discussed in more detail below, the techniques may be applied to the generation of workflows forming part of cybersecurity playbooks. The techniques therefore provide a means of rapidly and conveniently generating workflows that react to or mitigate security threats, thereby improving the safety of monitored systems.

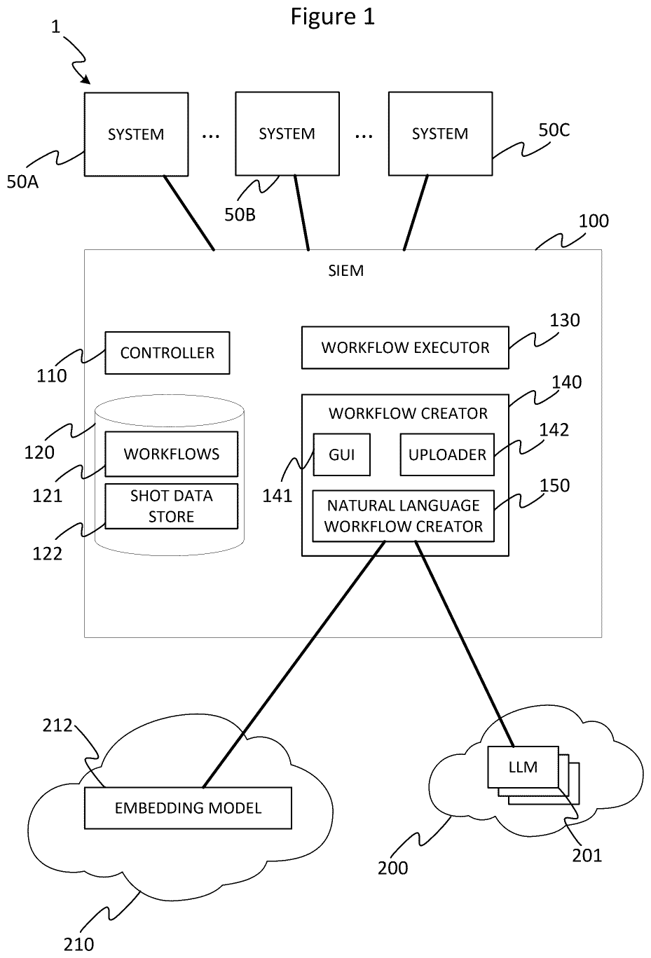

FIG. 1 illustrates a computing environment 1 in which examples of the invention may operate. In the example, the environment comprises an SIEM (Security Incident and Event Management) system 100. The SIEM 100 generally represents one or more software systems that are responsible for monitoring the environment to detect cybersecurity threats and responding by taking suitable mitigating action in response to a detected threat.

The SIEM 100 interfaces with a plurality of other computer systems 50A-C in the environment, so that it can monitor the other computer systems 50A-C for signs of cybersecurity threats. The SIEM 100 may also interface with the other computer systems 50A-C to take mitigating action. The other computer systems 50A-C include a wide variety of systems, such as file management systems, email systems, user access management systems, and the like. In general, each other computer system 50A-C is configured to run one or more applications, with which the SIEM 100 interfaces.

The SIEM 100 includes a controller 110, which includes one or more processors or other compute elements (e.g. GPUS, ASICs etc), configured to execute instructions to carry out any of the methods or functionality discussed herein. The SIEM also includes a storage 120 configured to store, transiently or permanently, any data or instructions to carry out any of the methods or functionality discussed herein.

The storage 120 also stores a plurality of workflows 121. Each workflow comprises a plurality of ordered actions which are executed in response to an initial trigger action. Each action represents one or more computational operations carried out during execution of the workflow. Example triggers are the occurrence of a pre-determined event (e.g. a security alert or incident), a scheduled start time or in response to a user request, as discussed in more detail below.

The workflows 121 are defined in a workflow definition language. For example, the workflows 121 are defined in JSON (Javascript Object Notation). In other examples, the workflows may be defined in XML, YAML, or any other suitable language or metalanguage that allows the definition of ordered actions. In some examples, the workflows are defined according to a schema, the schema defining the permitted structure and statements of the workflow.

The storage 120 furthermore stores a shot data store 122, which will be discussed in further detail below.

The SIEM 100 also includes workflow execution logic 130, also referred to herein as a workflow executor, which executes the workflow in response to the trigger action. The workflow execution logic 130 executes each of the actions in the workflow in an automated fashion (i.e. substantially without user intervention). For example, an action may involve one or more of the receipt of input data from one or more of systems 50A-C, the processing of received input data and/or the transmission of data to systems 50A-C. Each action may variously involve interacting with one or more of the other computer systems 50A-C, e.g. to query databases associated with the computer systems, change user access rights, access applications, send emails or other communications and so on.

In one example, the workflow executor 130 forms part of the Microsoft® Azure Logic Apps service or platform. The workflow definitions are therefore in JSON format compatible with the Azure Logic Apps schema. However, the workflow executor 130 can form part of any suitable automation platform or service, such as Workato, Boomi, Celigo, SAP Integration Suite, MuleSoft AnyPoint, Jitterbit Harmony, etc.

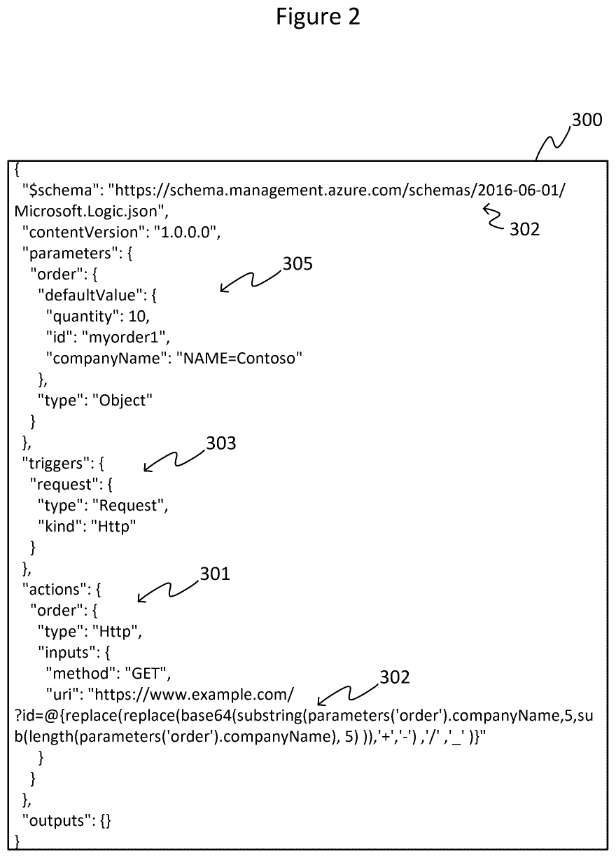

FIG. 2 illustrates an example workflow definition 300 in workflow definition language. In the example, the workflow definition is in the JSON format used by Microsoft® Azure Logic Apps. The example is a simple illustrative example that includes statements defining a single action 301 provides an input to an API indicated in uri field 302. The example also includes statements defining a trigger 303, which specifies the workflow is triggered on request. The definition 300 also includes statements identifying the schema 304, and defining input parameters 305.

In the context of the SIEM 100, the workflows 121 can form part of a security playbook. A security playbook is a set of predetermined responses or reactions to security events, that are to be carried out when an event is detected. The playbook forms part of a strategy for dealing with security threats, which ensures consistent action is taken upon threat detection to adequately investigate or mitigate the threat. A playbook may include automated workflows, but may also include steps to be carried out by human security analysts.

The SIEM 100 also includes workflow creation logic 140, also referred to herein as a workflow creator, configured to create new workflows or edit existing workflows. In some examples, the workflow creation logic 140 includes a GUI 141 displayable to a user to create or edit a workflow. In some examples, the workflow creation logic 140 alternatively or additionally includes a means of uploading workflows defined in a workflow definition language, labelled as uploader 142. As discussed in detail below, the workflow creation logic 140 furthermore includes logic 150 for creating a workflow based on a natural language description.

The environment 1 further includes one or more large language models (LLMs) 201. The LLMs 201 are examples of generative models. Each LLM 201 is a trained language model, based on the transformer deep learning network. Each LLM 201 is trained on a very large corpus (e.g., in the order of billions of tokens), and can generate text or data in response to receipt of an input in the form of a prompt.

An example of a suitable LLM 201 is the Open Al General Pretrained Transformer (GPT) model, for example GPT-3, GPT-3.5 turbo or GPT-4. However, a variety of LLMs 201 may be employed in the alternative.

The LLMs 201 operate in a suitable computer system 200. For example, the LLMs 201 are stored in a suitable data centre, and/or as part of a cloud computing environment or other distributed environment. Each LLM 201 is accessible via suitable APIs (application programming interfaces), for example over a network. The network comprises any suitable links, including wired and wireless links and local and wide area networks.

The SIEM 100 interfaces with the LLM 201 by providing inputs to the LLM and receiving responses. The input is referred to as a prompt, and includes instructions that, when processed by the LLM 201, cause the LLM 201 to provide a desired response.

The LLM 201 is configured to receive text as input and generate text in response. Accordingly, in this context, instructions to be processed by the LLM 201 refer to instructions provided in a natural language (e.g. in English) that can be received as input by the LLM 201 and processed thereby. The instructions generally comprise a textual explanation of the task and the form of the desired response. The instructions may comprise further contextual information that assists the LLM 201 in performing the task, such as a description of a persona to adopt, a description of relevant rules or conventions required to provide the output. In some examples, the prompt also comprises one or more training examples, referred to as shots. Shots are discussed in more detail below.

In examples, the process of constructing (or generating) the prompt includes retrieving one or more strings from the storage 120, such as template text. Template prompts may be referred to as metaprompts or system prompts, as distinct from prompts typed on the fly by users. In examples, the process also comprises generating one or more strings, for example by converting data extracted from the storage 120 (as discussed in more detail below) into strings. The resulting strings are then concatenated or otherwise combined to form the prompt. For example, each string may be loaded into memory, and combined to form a larger string comprising the prompt. The prompt is then stored in memory (e.g., in volatile memory) before being transmitted to the LLM 201, e.g., via an API call.

The response received from the LLM 201 is also in the form of text. The SIEM 100 is configured to extract relevant data from the response, e.g. by extracting suitable substrings from the string of text.

The environment 1 also includes an embedding model 212. The embedding model is configured to receive text and generate a vector representative of the text. The vector comprises a plurality of numerical values, which represent the text in an embedding space. For example, each numerical value is in the range 0 to 1, though in other examples the numerical values may be negative and/or in a different range. The number of numerical values present in the vector is referred to as the dimensionality of the vector.

The embedding model 212 generally represents the semantics (i.e. meaning) of the text in numerical form, such that texts that are similar in meaning result in vectors that are close to one another in the embedding space. For example, two texts that are synonymous but differently phrased will have a distance in the embedding space (e.g. measured by some suitable distance metric such as cosine difference) that is small. However, two texts with entirely different meaning will be far apart in the embedding space. Embedding models are widely used in a range of text processing tasks.

The embedding model 212 is a trained machine learning model that generates the vector from the input text. In one example, the trained machine learning model is the text-embedding-ada-002 model provided by Open Al (see https://platform.openai.com/docs/models/embeddings). This model generates embedding vectors with 1536 dimensions.

However, it will be understood that other embedding models may also be employed. For example, other embedding models provided by Open Al may equally be suitable (e.g. text-embedding-3-small, text-embedding-3-large etc). Other embedding models may also be suitable, including well-known models such as Word2Vec, GloVe, and FastText.

The embedding model 212 operates in a suitable computer system 210. For example, the embedding model 212 is stored in a suitable data centre, and/or as part of a cloud computing environment or other distributed environment. The embedding model 202 is accessible via APIs (application programming interfaces), for example over the network.

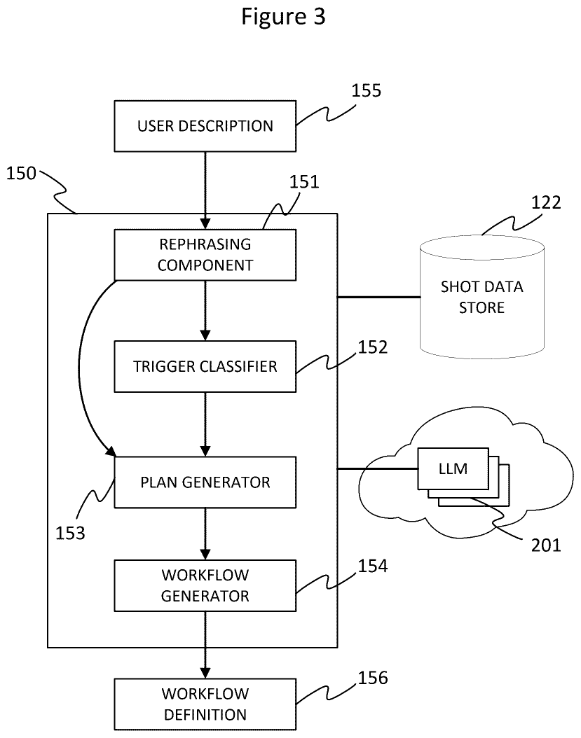

FIG. 3 illustrates an example of the logic 150 for creating the workflow based on a natural language description in more detail. In overview, the logic 150 comprises a rephrasing component 151, a trigger classifier 152, a plan generator 153 and a workflow generator 154.

The rephrasing component 151 receives as input a first natural language description 155 of a workflow (also referred to herein as a user description), and provides as output a second natural language description of a workflow. The second natural language description is rephrased so that it makes explicit detail inferred from the first natural language description.

The trigger classifier 152 receives as input the second natural language description, and provides as output the trigger action which is used to trigger execution of the workflow.

The plan generator 153 receives as input the second natural language description and the trigger action. The plan generator 153 generates a plan corresponding to the second natural language description. The plan takes the form of a list of actions in a pseudocode format.

The workflow generator 154 receives the structured list of actions from the plan generator, and provides as output a workflow definition 156 in the workflow definition language.

As illustrated in FIG. 3 and discussed in more detail below, one or more (or all) of the components of the logic 150 interface with one or more of the LLMs 201 to generate their respective outputs. The components 151-154 provide prompts to one or more of the LLMs 201, and receive respective responses. The components may make use of zero-shot, one-shot or few-shot learning techniques. In this context a “shot” is a training data item included in the prompt that provides guidance to the LLM in providing the required output. As the names suggest, a zero-shot technique includes no shots, a one-shot learning technique includes only one shot, and a few-shot learning technique includes a plurality of shots. In few-shot learning, a relatively small number of shots (e.g. less than 50, typically 10 or less) are included. This is in contrast to traditional supervised machine learning techniques in which thousands of training data examples are typically needed to train a model.

As also illustrated in FIG. 3 and discussed in more detail below, one or more (or all) of the components of the logic 150 interface with shot data store 122. The shot data store 122 acts as a repository of shots for use in the various prompts generated by the components 151-154. The data store 122 may take the form of any suitable data storage structure, such as a relational database, a non-relational (e.g. NoSQL) database, structured text files (e.g. in a CSV format) or the like.

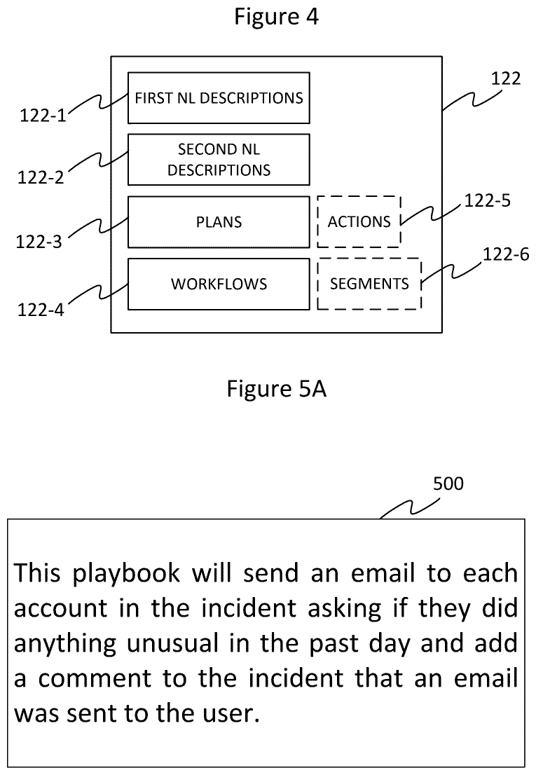

FIG. 4 illustrates the shot data store 122 in more detail. The shot data store comprises first natural language descriptions 122-1, second natural language descriptions 122-2, plans 122-3 and workflow definitions 122-4. The shot data store 122 further stores correspondences between the first natural language descriptions 122-1, second natural language descriptions 122-2, plans and workflow definitions. This allows, for example, given a first natural language description 122-1, the corresponding second natural language description 122-2, plan 122-3 and/or workflow definition 122-4 to be retrieved. Similarly, given any of a second natural language description 122-2, plan 122-3 or workflow definition 122-4, corresponding other items from the shot data store 122 can be retrieved.

In addition to storing the plans 122-3 and corresponding workflow definitions 122-4 in whole, in examples the data store 122 also stores individual actions 122-5 of the plan and corresponding segments 122-6 of workflow definitions. That is to say, each action comprised in a plan and its corresponding segment or statement of workflow definition language can be stored in the data store.

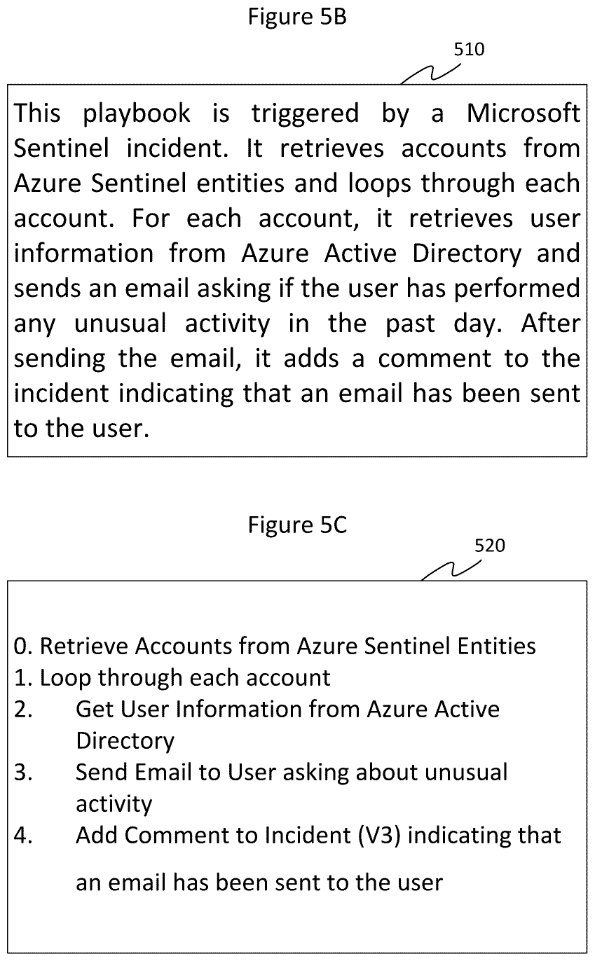

FIGS. 5A-C respectively illustrate a corresponding first natural language description 500, second natural language description 510 and plan 520.

The first natural language description 500, which may be provided by a user, generally explains the intention of the workflow and the steps it involves. The example shown states in a single sentence that the playbook sends an email to each account in the incident asking if they did anything unusual in the past day and add a comment to the incident that an email was sent to the user.

The second natural language description 510 is a more detailed description of the workflow. It includes multiple sentences, which generally correspond to an individual action to be included in the plan. It also sets out the trigger for the workflow.

The plan 520 is a set of actions, in a pseudocode form. Each action need not form a full sentence, and the pseudocode representation allows for logical constructs (e.g. loops, if/else or switch conditions). Actions that form part of one of the logical constructs are indented. For example, the steps that are numbered 2-4 are indented to show that they are repeated as part of the loop of the step numbered 1.

Although not illustrated, in examples each action in the plan 520 comprises a type and an action identifier. The identifier may be a unique identifier, e.g. a reference number or code. The type indicates the type of the action. For example, it may indicate that the action is a particular logical construct (i.e. a for loop, if statement, else statement, switch statement). One example type indicates that the identifier is an API connection statement, which involves interfacing with an API. Other examples of action types include actions which append data to strings or arrays, if statements, initializing or setting variables, http requests or responses, for statements, switch statements, wait statements, statements for composing JSON messages or other messages, and so on.

The action itself (i.e. the text defining the statement) is referred to herein as the title of the action. Alternatively, the title is a brief textual summary of the action.

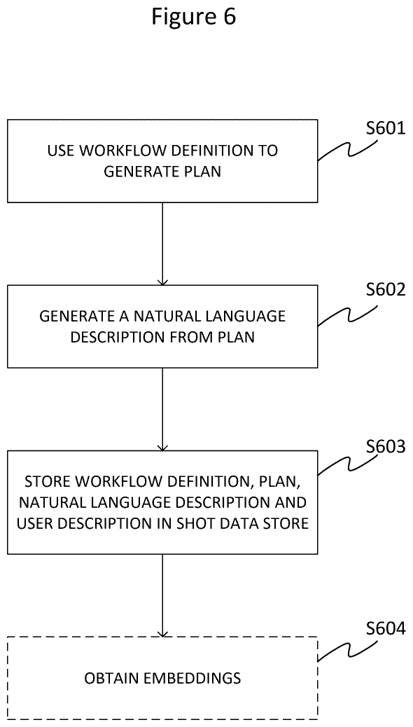

FIG. 6 illustrates an example technique for populating the shot data store 122.

The technique takes as input a plurality of workflow definitions and corresponding user descriptions of the workflow definitions. For example these are obtained from any suitable open-source repository. In an example, the workflow definitions and user descriptions were obtained from GitHub, specifically the GitHub repositories comprising Microsoft Sentinel and Microsoft Defender for Cloud workflows.

In a first step, S601 a workflow definition is used to generate a corresponding plan.

Particularly, the technique includes generating a prompt for an LLM 201 comprising the workflow definition. The prompt comprises instructions for the LLM 201, which cause the LLM 201 to generate a response including a plan corresponding to the input workflow definition. By instructions, it is meant text-based or natural language instructions that are interpretable by the LLM 201. The instructions included in the prompt comprise a description of the format of a plan and/or sets of permissible statements in a plan. In some examples, the instructions include that the plan comprises numbered statements wherein each statement corresponds to one or more instruction present in the workflow definition. In some examples, the instructions specify that for loops, conditional (e.g. “if”) statements, and/or other pseudocode-style programming constructs are permitted.

The prompt may be referred to herein as a plan shot generation prompt, in that it is a prompt for generating a shot comprising a plan.

The prompt need not include any shots, and be an example of a zero-shot learning technique.

In examples, the prompt also includes the trigger. That is to say, whilst the trigger is specified in the workflow description, it can additionally be extracted from the workflow description and provided separately in the prompt.

The prompt is input to the LLM 201, and in response the plan is received.

In a second step S602, the plan is used to generate a natural language description. The natural language description is akin to the second natural language description discussed herein, in that it provides a relatively detailed text summary of the actions in the plan.

In examples, the natural language description is also be generated using an LLM 201. A prompt is generated that comprises the plan. The prompt also comprises instructions for the LLM 201, which cause the LLM 201 to generate a response including the natural language description. The instructions for example set out that a text summary of the actions is required in response.

The prompt for generating the natural language description may also not include any shots, and thus is another example of a zero-shot learning technique. In some examples, the prompt also includes the trigger.

The prompt may be referred to herein as a natural language shot generation prompt, in that it is a prompt for generating a shot comprising the natural language description.

In a third step S603, the workflow definition, plan, natural language description and corresponding user description are stored in the shot data store 122. Accordingly, a set of corresponding workflow, plan, natural language description and user description are stored in the data store 122. The process is repeated for each of the workflow definitions in the plurality of workflow definitions initially received.

In a fourth step S604, optionally the technique comprises obtaining embeddings corresponding to any or all of the plan, natural language description and user description. This involves providing the plan, natural language description and user description to the embedding model 212 and receiving corresponding vectors respectively representing the plan, natural language description and user description in response. These embeddings are also be stored in the data store 122 for use in the techniques discussed herein.

In some examples, workflow definitions are obtained that do not have corresponding user descriptions. In this circumstance, the steps above are carried out to generate a corresponding plan and natural language description and store them in the data store 122, with the user description being omitted.

As discussed above, the shot data store 122 also stores the actions comprised within each plan and their corresponding segments of the workflow definition. Accordingly, in some examples, the technique further includes parsing the plan into individual actions and storing the actions in the data store 122, as well as parsing the workflow definition into individual segments. Each segment corresponds to a single statement or group of related statements in the workflow definition. The data store 122 may also store data indicating the correspondence between each action and segment.

In addition, in some examples a title is generated for each action. The title is for example a brief textual summary of the action, though in other examples it corresponds instead to the text of the action. In one example, the title is generated using the LLM 201, by generating and submitting a prompt including instructions that cause the LLM 201 to summarise the action. In some examples, the prompt includes shots comprising corresponding actions and action titles. In some examples, embeddings are also generated and stored for the actions and/or the titles.

In one example, a collection of 431 workflow definitions were acquired from the GitHub repositories comprising Microsoft Sentinel and Microsoft Defender for Cloud workflows, of which 269 included a user description.

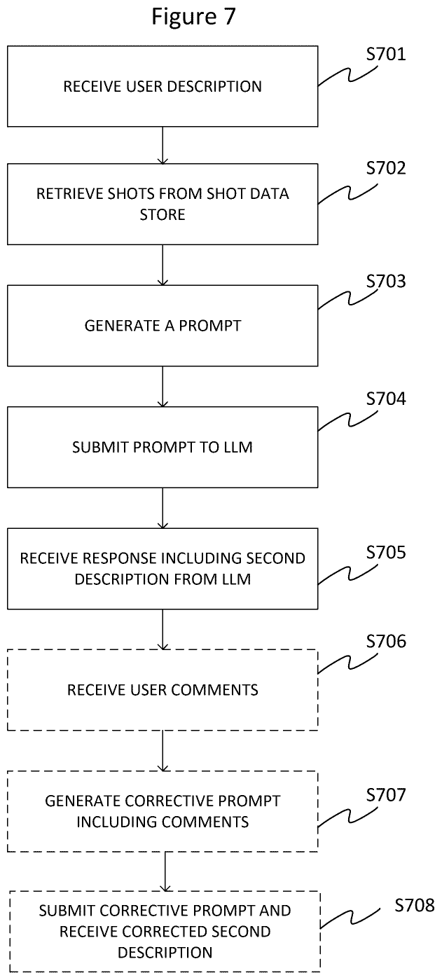

FIG. 7 illustrates an example of the functionality of the rephrasing component in more detail 151.

From analysis of input user descriptions, it has been found that the user descriptions are often brief and lack sufficient detail to infer a comprehensive action plan therefrom. Accordingly, the rephrasing component 151 is configured to generate a second natural language description including more detail that provides a better basis from which to infer a plan.

In a first step S701, the rephrasing component 151 receives a user description.

In a second step S702, the rephrasing component 151 retrieves a plurality of shots from the shot data store 122, each shot comprising a user description and a corresponding natural language description. These shots may be referred to as rephrasing shots.

For example, the rephrasing component 151 generates an embedding of the received user description. The embedding of the user description is used to retrieve identify similar user descriptions in the shot data store 122. For example, the distance in embedding space is calculated between the received user description and each user description stored in the data store 122. As discussed above, the embeddings of the user descriptions can be calculated during the process of populating the data store 122, so that they can simply be retrieved, though in other examples the embeddings are calculated at runtime.

Example similarity metrics include cosine distance and Manhattan distance. The k most similar user descriptions are then selected to form the plurality of shots. K can be any suitable number, such as 5, 10, 15, 20, or 50.

In other examples, other techniques for retrieving the shots are employed. For example, TF-IDF scores or machine learning techniques are employed to select the most relevant shots.

In a third step S703, a prompt is generated comprising the shots. The prompt is referred to herein as a rephrasing prompt. The prompt comprises instructions that cause an LLM 201 to generate the second description from the received user description. These instructions for example explain the expected contents of the second description. The instructions can also set out details of the role or persona of the user—e.g. that they are a security analyst setting out details of an automated workflow.

In fourth and fifth steps S704-S705, the prompt is submitted to the LLM and a response is received from the LLM 201. The response includes the second description.

As discussed further hereinbelow, in some examples the generated second description is displayed to a user via a suitable user interface. Optionally, in a sixth step S706, the user provides comments on the second description in the event that the second description is not accurate. In response to the receipt of comments, in a seventh step S707, a further prompt is generated, which includes the second description, the comments and instructions to rephrase the second description taking into account the comments. This prompt may be referred to as a corrective description prompt. In an eighth step S708, the prompt is input to an LLM 201 a response is received including the rephrased second description, which then replaces the earlier second description.

In some circumstances, the rephrasing component 151 is omitted. For example, in circumstances where written descriptions of the workflow are provided that include sufficient detail to form a reliable basis for generating a plan, there may be no need to rephrase the descriptions.

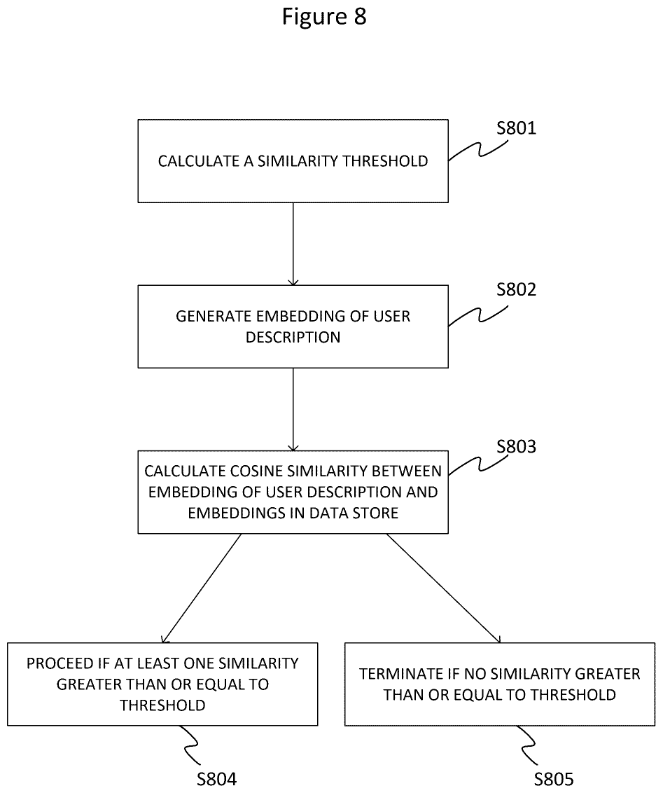

FIG. 8 illustrates further optional functionality of the rephrasing component 151. It is desirable to prevent the generation of workflows that correspond to malicious use cases, and/or prevent the generation of workflows for which sufficiently similar training data (i.e. shots) is not available. Accordingly, before proceeding with rephrasing or any subsequent steps, the received user description is assessed to determine whether it is sufficiently similar to the user descriptions in the data store 122. In the event that the received user description is not sufficiently similar to the user descriptions in the data store 122, further steps of the process are not carried out. In other words, the procedure only continues in the event that the received user description is sufficiently similar to the user descriptions in the data store 122.

In a first step S801, a similarity threshold is calculated based on the user descriptions stored in the data store 122. In one example, the similarity threshold is defined by the following formula:

$${threshold}_{sim} = min ( \{ max ( \{ cosine\_similarity ( {e}_{i} , {e}_{j} ) \vert ∀ j != i \} \vert ∀ i \leq N \} )$$

where N is the number of user descriptions in the data store 122 and eᵢ and eⱼ are respectively individual user descriptions drawn from the data store 122. In effect, this formula defines that, for a given description eᵢ, the cosine similarity is calculated between the description eᵢ and each other description eⱼ. The maximum cosine similarity is then determined from amongst these similarities. This effectively is the distance between the description eᵢ and the most similar other description eⱼ in the data store. This is carried out for each description eᵢ thus resulting in a list of the maximum cosine similarity for each description. The smallest cosine distance in the list is selected as the threshold.

In some examples, the threshold is calculated in advance and stored, such that it need not be calculated at runtime but instead is retrieved from storage 120.

In a second step S802, an embedding of the received user description is generated. This may be the same embedding discussed above in relation to FIG. 7.

In a third step S803, the cosine similarity is calculated between the embedding of the received user description and each of the user descriptions in the data store.

In the event that at least one of the cosine similarities is greater than or equal to the threshold, the process proceeds in step S804. In the alternative, where none of the cosine similarities are greater than or equal to the threshold, the process terminates without carrying out the further steps of generating the workflow based on the input description in step S805.

In circumstances where the rephrasing component 151 is omitted, the same procedure can be carried out with respect to the second natural language descriptions in the data store.

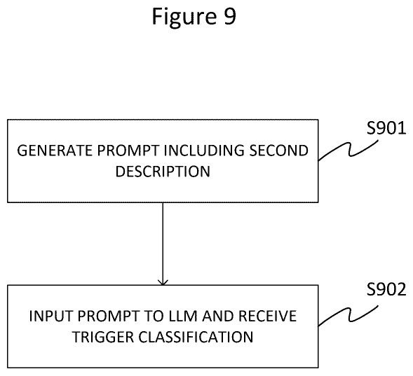

FIG. 9 illustrates the functionality of the trigger classifier 152. The trigger classifier 152 receives the second natural language description as input, and determines the trigger action therefrom.

In one example, there are six possible trigger actions for an automated workflow. These are incident, alert, entity, recurrence, batch, request.

An alert is an event detected by the SIEM. Examples include failed logins, brute force access attempts, situations where access attempts from different geographical locations are indicative of impossible travel, activities from unusual geographic locations, suspicious emails and so on.

An incident can correspond to or be generated by the SIEM in response to multiple alerts. In other words, an incident is a group of related alerts that are indicative of an ongoing security incident.

An entity corresponds to a particular account, host, IP address, URL, or application.

Recurrence corresponds to a scheduled workflow that is executed periodically. For example, it may be hourly, daily, weekly etc.

Batch corresponds to a workflow that collects input (e.g. messages) and waits until specified criteria are met in respect of the input before executing the workflow.

Request corresponds to a workflow that is executed in response to a request. In other words, the workflow is executed manually, in response to user input.

It will be understood that these are merely an example set of triggers that apply to the security domain. In some examples, fewer than the six triggers discussed above are classified. In other examples, more or different triggers are employed.

In a first step S901, a prompt is generated including the second description. The prompt includes instructions that cause the LLM 201 to classify the trigger action. This for example includes an explanation of each trigger and when it should be used. The prompt may be referred to herein as a triggered detection prompt.

In some examples, the prompt is a zero-shot prompt. For example, it has been found that the GPT-4 LLM provides suitably accurate trigger classification without shots. However, in other examples, shots comprising pairs of descriptions and corresponding triggers may be included in the prompt. Such shots are retrieved in a similar manner to the retrieval of shots discussed above, based on the similarity of an embedding of the second description to other second descriptions stored in the shot data store.

In a second step S902, the prompt is provided as input to the LLM 201 and a response is received comprising the classification of the trigger.

In other examples, suitable trained or fine-tuned machine learning models may instead be employed for trigger classification. For example, a support vector machine, trained on corresponding second descriptions and triggers is employed.

In some examples, trigger classification may be omitted. For example, the user instead provides user input indicating the trigger (e.g. selecting from a list or the like). Alternatively, in some examples it is inferred from the context or assumed that the trigger is a particular trigger. For example, the process may be a process for generating batch workflows or a process for generating request workflows, in which case it can be assumed that the trigger is batch or request respectively.

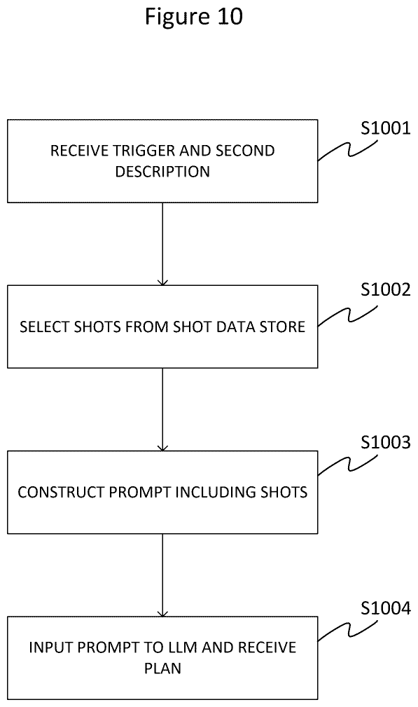

FIG. 10 illustrates the functionality of the plan generator 153.

In a first step S1001, the plan generator 153 takes as input the trigger and the second description.

In a second step S1002, the plan generator 153 selects one or more shots (i.e. k shots) from the shot data store 122. Each shot comprises a second description and a corresponding plan, and may be referred to herein as a plan generation shot. As discussed herein, relevant shots are selected based on the similarity of the input second description to the second descriptions stored in the data store, for example using cosine distance. However, any other suitable method of selecting the shots can be employed.

In one example, k is 10, but as before k may be any suitable value such as 1, 2, 5, 15, 20, 25 or 50.

In a third step S1003, the plan generator 153 constructs a plan generation prompt including the selected shots. The prompt includes instructions that cause the LLM to generate the plan from the second description and trigger. For example, this includes a description of the task. In some examples, it also includes details of permitted statements in the plan. In examples, the prompt includes instructions that cause the LLM 201 to generate a title and an action type for each action in the plan.

In a fourth step S1004, the prompt is provided as input to the LLM and a response is received comprising the plan.

Although not illustrated, in some examples the plan generator is further configured to receive user comments on the plan, and correct the plan accordingly by constructing a corrective plan generation prompt that causes the LLM to correct the plan based on the user comments, in a similar manner to as discussed above in relation to the second description.

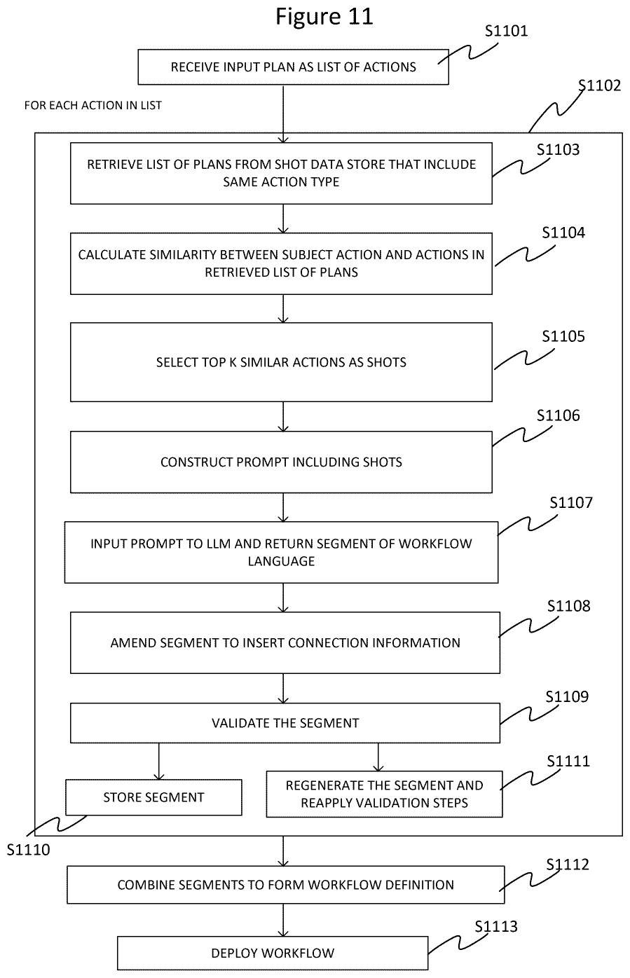

FIG. 11 illustrates the functionality of the workflow generator 154.

In overview, the workflow generator 154 iterates through each action in the plan to generate corresponding statements in the workflow definition language. For each action, a prompt is generated comprising the input action and a plurality of shots. The shots are in the form of pairs of actions and corresponding segments of workflow definition language.

Initially, in a first step S1101, the plan is received, which comprises a list of actions as discussed above.

For each action in the list (referred to below as the subject action), a plurality of shots are selected. The loop is illustrated as step S1102 in FIG. 11.

To accomplish this, initially (S1103) a list of plans is retrieved from the shot data store 122 that include an action having the same action type as the subject action. For example, if the action type of the input action is API connection, only plans that include API connection actions are retrieved.

Next, in step S1104, a similarity score is calculated between the subject action and each of the actions in each plan in the retrieved list of plans. In one example, a metric is calculated that takes into account both the similarity of the plans as a whole, as well as the similarity between the titles of the actions.

A first score is calculated that is reflective of the similarity between the title of the subject action and the title of an action in the retrieved list. In one example, this is a first cosine distance between respective embeddings of the titles. A second score is also calculated that is reflective of the similarity between the generated plan (i.e. the output of plan generator 153) and the plan containing the action from which the first score is calculated. This is for example a second cosine distance between respective embeddings of the two plans. The first and second score are then combined. For example, the scores are added, though in other examples the scores are combined in other ways, such as by calculating their mean.

In other examples, the metric is the first score or the second score.

Next, in step S1105, the top k most similar actions are selected as shots for inclusion in the prompt. Each shot includes the action (i.e. the action title) and the corresponding segment of workflow definition language.

Next, in step S1106 a prompt is constructed including the shots. The prompt includes instructions that cause the LLM 201 to generate a segment of workflow definition language corresponding to the subject action. In examples, the prompt also includes further information that may assist the LLM 201 in accurately generating the segment of workflow definition language. For example, the prompt includes any preceding segments of workflow definition generated in respect of preceding actions in the list. In examples, it also includes a list of variables already included in the preceding segments of workflow definition language.

The prompt is then input to the LLM in step S1107, and in response a segment of workflow language is returned.

If required, the segment is then amended to insert any suitable information such as account details or connection details in step S1108. For example, a segment that requires an API connection, the connection details are inserted.

In examples, after generation of the segment, the workflow generator 154 validates the segment in step S1109.

For example, the current segment and any preceding segments are concatenated to form the workflow definition language generated during the process so far. This is then parsed with a suitable schema validation tool to detect erroneous generated workflow language, such as malformed statements or statements that otherwise do not form valid workflow language.

If the workflow definition language generated so far passes the validation by the schema validation tool, the workflow generator then attempts to deploy the definition. That is to say, the workflow execution logic of the SIEM includes logic for importing a workflow definition ready for execution. As part of the deployment, the workflow execution logic performs further validation.

In the event that the segment passes validation, it is stored and the process repeats for the next action in the list in step S1110.

In the event that the segment fails validation, the LLM 201 is used to regenerate the segment in step S1111. For example, a prompt is constructed that includes any error message output by either validation attempt, the segment and instructions to correct the segment to rectify the error. This prompt is then submitted to the LLM 201 and a response is received comprising the rectified segment.

The validation steps are then applied again to the rectified segment. If necessary, these steps are repeated multiple times until a segment that passes validation is generated.

Once a segment has been generated for each action in the list, the segments are combined to form the workflow definition in step S1112. For example, the strings of each segment are concatenated. In examples, the combination of the segments maintains their order and dependencies. For example, actions that appear in the plan as part of an if statement are located with an if statement in the generated workflow definition language. The workflow is then deployed in step S1113.

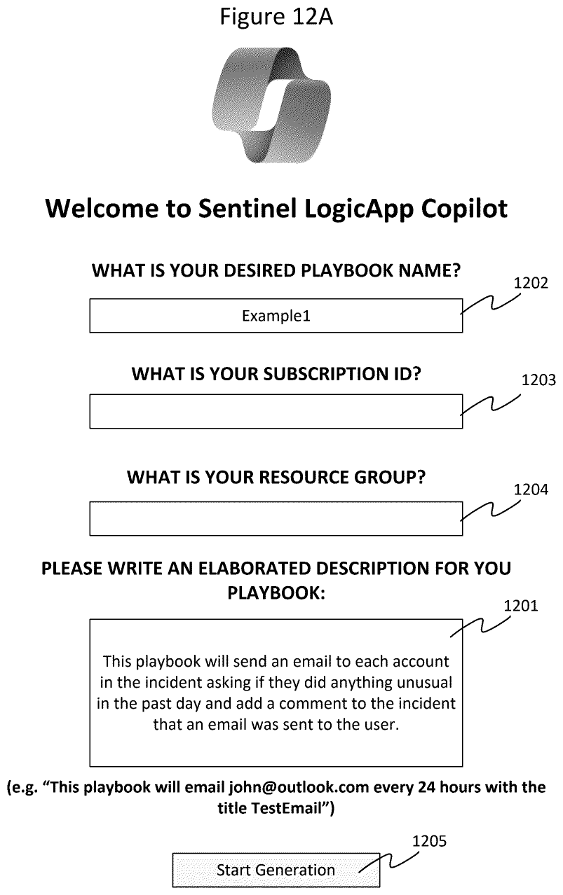

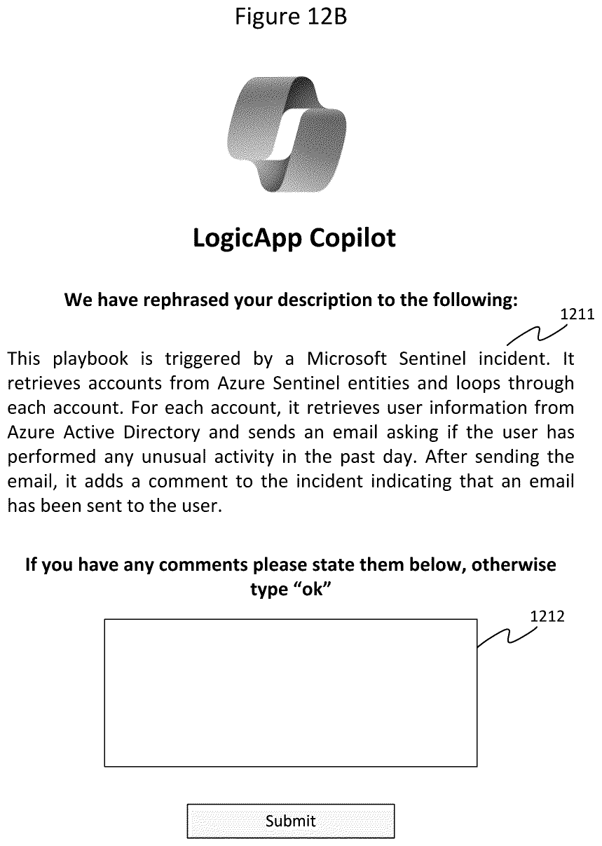

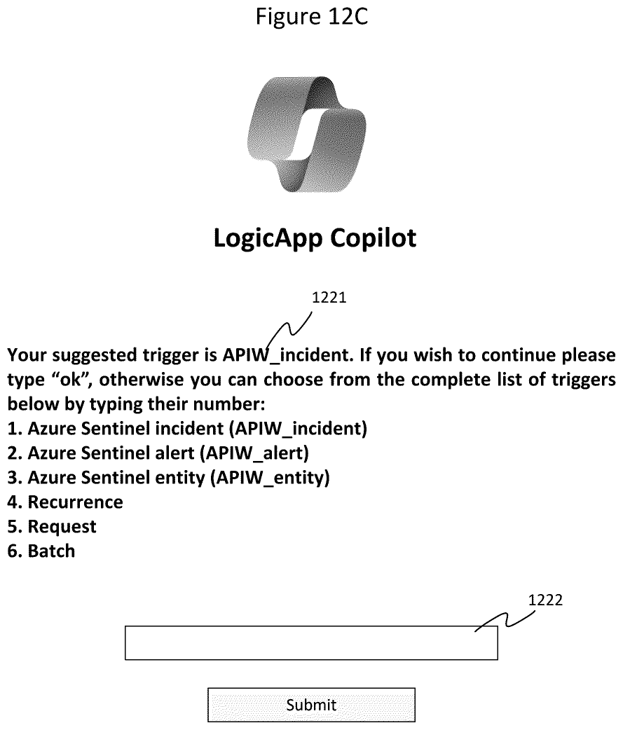

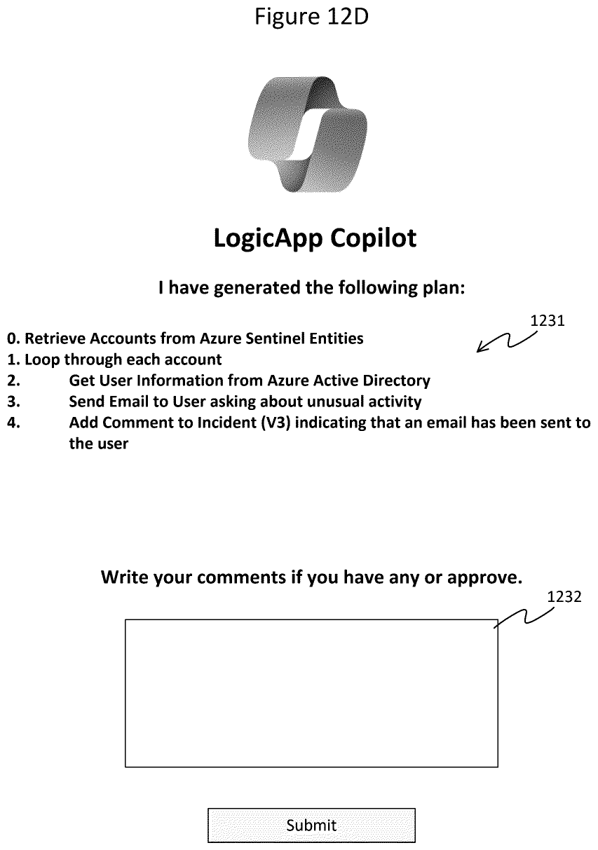

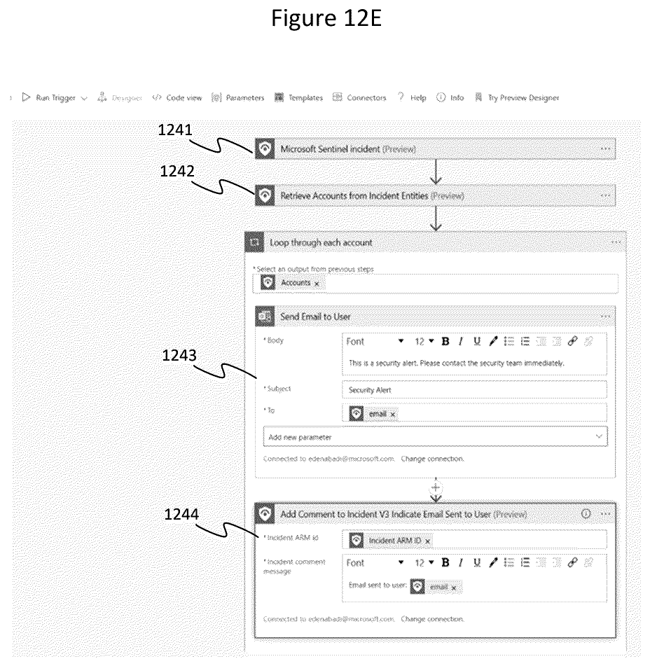

Turning now to FIGS. 12A-E, user interfaces associated with the generation of a workflow from a natural language description will now be described.

FIG. 12A illustrates a first user interface for inputting a natural language description. The user interface includes a text box 1201 that allows a user to enter the natural language description. In addition, the user interface includes further input means 1202-1204 for providing a name for the workflow, as well as other relevant account details. A button 1205 is provided to submit the natural language description, which triggers the rephrasing component to generate the second natural language description.

FIG. 12B illustrates a second user interface, which displays the generated second natural language description 1211 to the user. The second user interface also includes a text box 1212 for the receipt of user comments on the generated second natural language description. In response to the receipt of the user comments, the steps of rephrasing the second natural language description discussed above are carried out, and the second user interface is refreshed to include the rephrased description.

In response to the receipt of an indication that the second natural language description (or the rephrased version thereof where applicable) is acceptable, the second natural language description is stored for use in trigger classification and plan generation. In the example user interface, this is accomplished by the user entering “ok” in the text box, but it will be understood that alternative input means (e.g. a button) could be provided.

FIG. 12C illustrates a third user interface, which displays the output of the trigger classifier. The user interface includes an indication 1221 of the detected trigger in the second natural language description. The user interface also includes input means 1222 that allow a user to select an alternative trigger, in the event that the detected trigger is incorrect.

FIG. 12D illustrates a fourth user interface, which displays the plan 1231 generated by the plan generator. Similarly to the second user interface, the fourth user interface also includes a text box 1232 for the receipt of user comments on the generated plan. In response to the receipt of the user comments, the plan is corrected as discussed above, and the fourth user interface is refreshed to include the rectified plan.

In response to the receipt of an indication that the plan (or the rectified version thereof where applicable) is acceptable, the plan is stored for use in workflow definition generation. In the example user interface, this is accomplished by the user entering “ok” in the text box, but it will be understood that alternative input means (e.g. a button) could be provided.

FIG. 12E illustrates a fifth user interface, which is an example of a user interface of the workflow creation logic 140. The workflow created and deployed as a result of the processes discussed herein is displayed in an editable fashion. The user is able to interact with any of the steps of the workflow to edit them.

For example, the user interface includes dialogs 1241-1244 which correspond to the steps of the plan. Each dialog 1241 includes editable elements that allow the user to customize or edit the workflow. The workflow is presented as a flow chart, allowing the user to change the order of the steps of the plan.

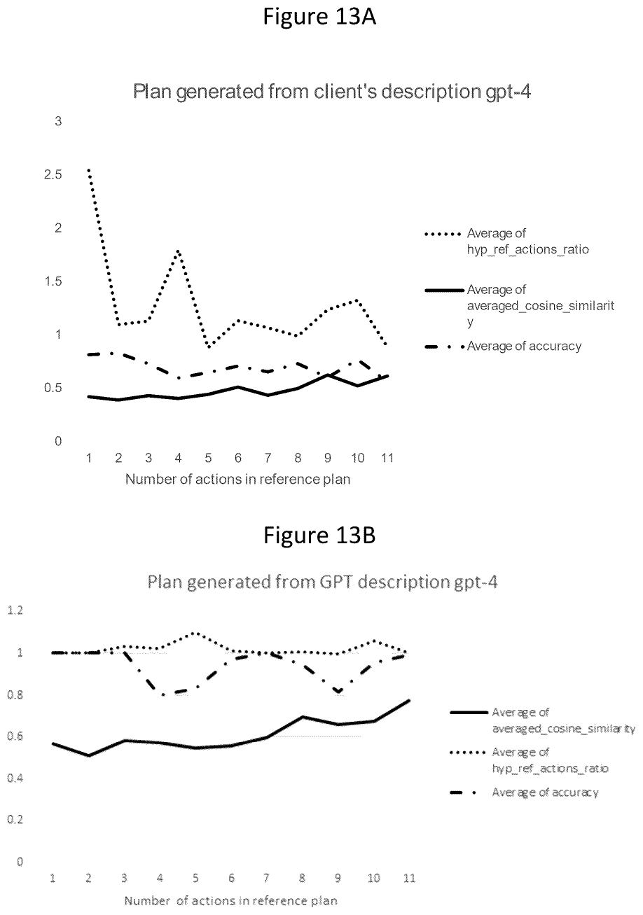

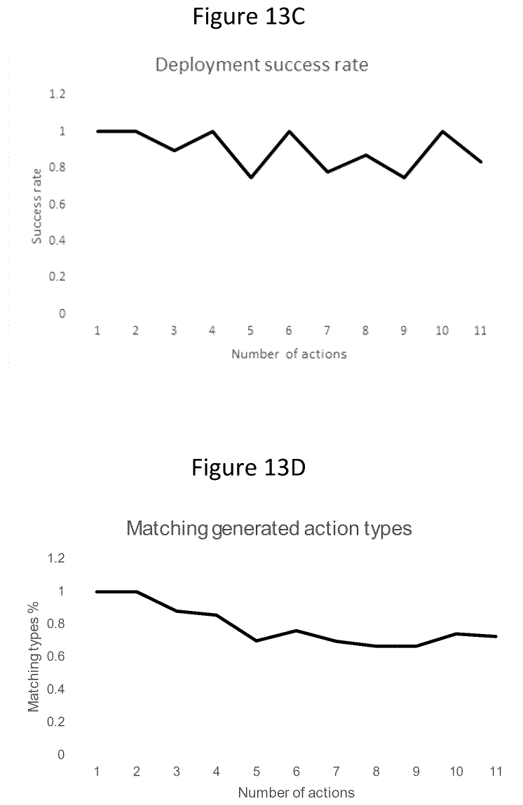

FIGS. 13A-D illustrate results of experiments demonstrating the efficacy of the techniques discussed herein.

FIGS. 13A and B respectively illustrate the performance of plans generated from user descriptions (i.e. without rephrasing) and from the rephrased second descriptions. Three metrics are provided. The first, represented by the dotted line, is (hypothesis plan number of actions)/(reference plan number of actions), where the reference plan is a ground truth plan. Values close to 1 indicate that the same number of actions are present in each plan. The second metric, represented by the solid line, is the accuracy of the reference plan tree as a subtree in the hypothesis plan based on a comparison of action types. The third metric, represented by the dashed and dotted lie, is an average of the cosine similarity of action names in the hypothesis sub-tree compared to action names in the reference plan. As shown, the rephrased description provides improved performance in plan generation.

FIGS. 13 C and D respectively illustrate the success rate of deployment of the generated workflow, and the percentage of actions in a generated workflow that match a ground truth workflow. As can be seen, the generated workflows correspond well to ground truth examples and in general deploy successfully, especially for smaller numbers of actions.

In addition, an evaluation of the trigger classification gave a weighted f1 score of 74.7%.

These experiments were based on the corpus of workflows retrieved from GitHub discussed above.

Various alterations or modifications to the above-described examples are possible within the scope of the disclosure.

It will be understood that the environment of FIG. 1 is merely an example. The teaching herein, whilst suitable and intended for application to security systems such as the SIEM, is equally applicable to a wide variety of other systems that employ automated workflows. For example, instead of security systems the teaching can be applied to e.g. IT helpdesk/servicedesk management and issue resolution. The workflows can be used to automate a wide range of processes including the automated sending of emails or messages (e.g. Teams® messages, SMS messages etc) in response to events, the automated movement of files in response to events, the monitoring of social media messages, the automated generation of program code and so on.

Whilst the examples illustrated include embedding models and LLMs that are hosted remotely from the workflow creator, it will be understood that in other examples either or both of the embedding model and LLMs could reside on the same computer device or same computer system as the workflow creator.

Whilst the examples illustrated show the workflow creator and/or executor incorporated into the SIEM, it can be deployed on any suitable computer system. In addition, whilst the examples show the workflow executor interfacing with remote systems or applications, it will be appreciated that in some examples the applications can reside on the same computer system as the workflow executor, such that the applications are local applications.

It will be appreciated that different LLMs may be used for different ones of the tasks discussed herein. For example, more complex LLMs are employed for some tasks, but others are carried out with less complex LLMs. In other examples, one LLM performs all of the tasks discussed herein. References herein to providing an prompt as input to at least one LLM refer to providing prompts to either the same LLM or different LLMs of a plurality of LLMs.

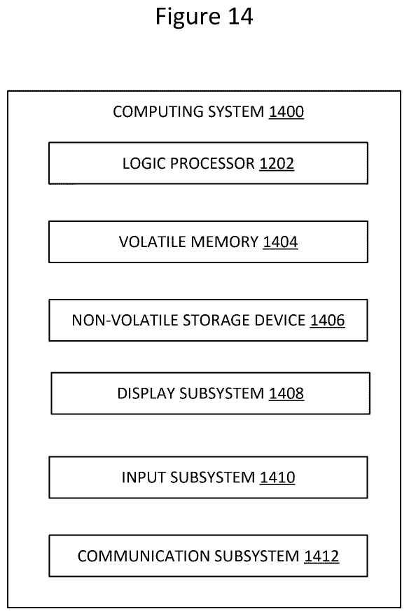

FIG. 14 schematically shows a non-limiting example of a computing system 1400 that can enact one or more of the methods and processes described above. Computing system 1400 is shown in simplified form. Computing system 1400 may embody any of the computer devices 50, 100, 200 or 210 described above, or any other computer device discussed herein. Computing system 1400 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 1400 includes a logic processor 1402, volatile memory 1404, and a non-volatile storage device 1406. Computing system 1400 optionally includes a display subsystem 1408, input subsystem 1410, communication subsystem 1412, and/or other components not shown in FIG. 14.

Logic processor 1402 includes one or more physical devices configured to execute instructions. For example, the logic processor is configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor includes one or more physical processors (hardware) configured to execute software instructions. Additionally or alternatively, the logic processor includes one or more hardware logic circuits or firmware devices configured to execute hardware-implemented logic or firmware instructions. Processors of the logic processor 1402 may be single-core or multi-core, and the instructions executed thereon may be configured for sequential, parallel, and/or distributed processing. Individual components of the logic processor optionally are distributed among two or more separate devices, which may be remotely located and/or configured for coordinated processing. In examples, aspects of the logic processor are virtualized and executed by remotely accessible, networked computing devices configured in a cloud-computing configuration. In such a case, these virtualized aspects are run on different physical logic processors of various different machines, it will be understood.

Non-volatile storage device 1406 includes one or more physical devices configured to hold instructions executable by the logic processors to implement the methods and processes described herein. When such methods and processes are implemented, the state of non-volatile storage device 1206 may be transformed—e.g., to hold different data.

Non-volatile storage device 1406 may include physical devices that are removable and/or built-in. Non-volatile storage device 1206 includes any of optical memory (e g., CD, DVD, HD-DVD, Blu-Ray Disc, etc), semiconductor memory (e g., ROM, EPROM, EEPROM, FLASH memory, etc.), and/or magnetic memory (e.g., hard-disk drive), or other mass storage device technology. Non volatile storage device 1406 includes any of nonvolatile, dynamic, static, read/write, read-only, sequential-access, location-addressable, file-addressable, and/or content-addressable devices. It will be appreciated that non-volatile storage device 1406 is configured to hold instructions even when power is cut to the non-volatile storage device 1406.

Volatile memory 1404 may include physical devices that include random access memory. Volatile memory 1404 is typically utilized by logic processor 1402 to temporarily store information during processing of software instructions. It will be appreciated that volatile memory 1404 typically does not continue to store instructions when power is cut to the volatile memory 1404.

Aspects of logic processor 1402, volatile memory 1404, and non-volatile storage device 1406 may be integrated together into one or more hardware-logic components. Such hardware-logic components include, for example, field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1400 typically implemented in software by a processor to perform a particular function using portions of volatile memory, which function involves transformative processing that specially configures the processor to perform the function. Thus, a module, program, or engine can be instantiated via logic processor 1402 executing instructions held by non-volatile storage device 1406, using portions of volatile memory 1404. It will be understood that different modules, programs, and/or engines can be instantiated from the same application, service, code block, object, library, routine, API, function, etc. Likewise, the same module, program, and/or engine can be instantiated by different applications, services, code blocks, objects, routines, APIs, functions, etc. The terms “module,” “program,” and “engine” can encompass individual or groups of executable files, data files, libraries, drivers, scripts, database records, etc.

When included, display subsystem 1408 can be used to present a visual representation of data held by non-volatile storage device 1406. The visual representation takes the form of a graphical user interface (GUI). Because the herein described methods and processes change the data held by the non-volatile storage device, and thus transform the state of the non-volatile storage device, the state of display subsystem 1408 may likewise be transformed to visually represent changes in the underlying data. In examples, display subsystem 1408 includes one or more display devices utilizing virtually any type of technology. Such display devices can be combined with logic processor 1402, volatile memory 1404, and/or non-volatile storage device 1406 in a shared enclosure, or such display devices are peripheral display devices.

When included, input subsystem 1410 comprises or interfaces with one or more user-input devices such as a keyboard, mouse, touch screen, or game controller. In some examples, the input subsystem comprises or interfaces with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1412 is configured to communicatively couple various computing devices described herein with each other, and with other devices. Communication subsystem 1412 may include wired and/or wireless communication devices compatible with one or more different communication protocols. As non-limiting examples, the communication subsystem is configured for communication via a wireless telephone network, or a wired or wireless local- or wide-area network. In some examples, the communication subsystem allows computing system 1400 to send and/or receive messages to and/or from other devices via a network such as the internet.

Additional example features of the disclosure are set out below.

According to a first aspect of the disclosure, there is provided a computer-implemented method of generating workflow definitions in workflow definition language, the method employing at least one large language model, LLM, the method comprising: receiving a natural language description of an automated workflow; generating a plan generation prompt including the natural language description and plan generation instructions; providing the plan generation prompt as input to the at least one LLM, and receiving in response a structured plan comprising a plurality of actions; generating a plurality of segments of workflow definition language by generating, for each action in the plurality of actions, a corresponding segment of workflow definition language; and generating a workflow definition corresponding to the natural language description by combining the plurality of segments of workflow definition language.

The natural language description may be a second natural language description. The method may further comprise: receiving a first natural language description from a user; generating a rephrasing prompt including the first natural language description and rephrasing instructions; providing the rephrasing prompt as input to the at least one the LLM and receiving in response a second natural language description, the second natural language description providing a more detailed description of the workflow than the first natural language description.

The method may comprise retrieving a rephrasing shot from a shot data store. The rephrasing shot may comprise an example first natural language description and a corresponding example second natural language description, based on a similarity of the example first natural language description to the received first natural language description. The method may comprise including the rephrasing shot in the rephrasing prompt. Retrieving the rephrasing shot based on the similarity may comprise determining a cosine similarity between the received first natural language description and each of a plurality of example first natural language descriptions in the data store, and selecting the rephrasing shot having the example first natural language description with the greatest cosine similarity. The method may comprise selecting k rephrasing shots with the greatest cosine similarity and including the k rephrasing shots in the rephrasing prompt.

The shot data store may comprise a plurality of example first natural language descriptions. The method may comprise determining, for each of the plurality of example first natural language descriptions, a similarity between the example first natural language description and the received first natural language description. The method may include, in response to determining that none of the determined similarities is greater than or equal to a similarity threshold, terminating the method before generating the action generation prompt.

The method may include calculating the similarity threshold by, for each first natural language description in the shot data store, calculating a cosine distance between the first natural language description and each other first natural description in the shot data store; selecting for each first natural language description a maximum cosine distance among the calculated cosine distances; selecting, as the similarity threshold, the smallest maximum cosine distance.

The method may include retrieving a plan generation shot from a shot data store comprising an example natural language description and a corresponding example structured plan, based on a similarity of the example natural language description to the natural language description; and including the plan generation shot in the action generation prompt. The similarity may be a cosine distance. The method may include retrieving a plurality of plan generation shots.

The method may comprise displaying the structured plan on a user interface. The method may comprise receiving user input comprising comments in relation to the structured plan; generating a corrective plan generation prompt comprising the user comments, the structured plan and corrective plan instructions; and providing the corrective plan generation prompt as input the at least one LLM and receiving in response a corrected structured plan based on the user comments.

Generating each corresponding segment of workflow definition language may comprise generating a workflow definition prompt including the respective action and workflow definition generation instructions; and providing the workflow definition prompt as input to the at least one LLM and receiving in response the respective segment of workflow definition language.

The method may comprise retrieving a plurality of structured plans from a shot data store that include an action corresponding in type to the respective action; determining for each action in each of the retrieved plurality of structured plans, a similarity metric between the action in the retrieved structured plan and the respective action, the similarity metric being based on the similarity of the action in the retrieved structured plan and the respective action, the similarity metric being further based on the similarity of the retrieved structured plan and the generated structured plan; selecting a plurality of the actions based on the determined similarity metrics; retrieving corresponding segments of workflow definition language from the shot data store for each selected action of the plurality of actions corresponding in type to the respective actions; including, in the workflow definition prompt, the plurality of actions and corresponding segments of workflow definition language as shots.

The method may comprise validating the respective segment of workflow definition language; in response to the respective segment of workflow definition language failing validation receiving an error message indicative of reasons for the respective segment failing the validation; generating a segment correction prompt including the error message, the respective segment and validation correction instructions; providing the segment correction prompt to the at least one LLM and receiving in response a corrected segment of workflow definition language.

The method may comprise detecting a trigger action of the workflow from the natural language description; and including, in the plan generation prompt, the trigger action. Detecting the trigger action may comprise: generating a trigger detection prompt comprising the natural language description and trigger detection instructions that, when processed by an LLM of the one or more LLMs, cause the LLM to detect the trigger action from the natural language description; and providing the trigger detection prompt as input to the at least one LLM and receiving in response the trigger action.

The method may comprise deploying the workflow definition to a workflow executor. The method may comprise displaying the automated workflow defined by the workflow definition in an editing user interface associated with the workflow executor.

The automated workflow may be a security workflow forming part of a security playbook. The workflow may be executed by workflow execution logic associated with a security incident and event management system.

The optional features defined above in relation to the first aspect may be combined in any combination. Accordingly, each sentence in the optional features defined above can be read as if it is a dependent claim referring to the features of any preceding sentence.

According to a second aspect of the disclosure there is provided a computer-implemented method of generating a shot data store for use in generation of automated workflows in workflow definition language from natural language, comprising: receiving a workflow definition in a workflow definition language and a user description of the workflow definition; generating, from the workflow definition, a structured plan comprising a plurality of actions corresponding to the workflow definition; generating, from the structured plan, a natural language description of the workflow definition; storing the workflow definition, the structured plan, the natural language description and the user description in a shot data store.

The method may comprise: generating a plan shot generation prompt including the workflow definition and plan generation instructions; providing the plan shot generation prompt to the LLM and receiving the structured plan in response.

The method may comprise: generating a natural language shot generation prompt including the structured plan and natural language shot instructions; providing the natural language shot generation prompt to the LLM and receiving the natural language description in response.

The method may comprise: generating respective embeddings of the workflow definition, the structured plan, the natural language description and the user description, and storing the generated embeddings in the shot data store.

The optional features defined above in relation to the second aspect may be combined in any combination. Accordingly, each sentence in the optional features defined above can be read as if it is a dependent claim referring to the features of any preceding sentence.

The first and second aspects may be combined. That is to say, a method of generating workflows as set out in the first aspect based on the shot data store generated by the second aspect may be provided.

A fourth aspect of the present disclosure provides a computer-implemented method of generating workflow definitions in workflow definition language, the method employing a large language model, LLM, the method comprising: receiving a natural language description of an automated workflow; generating a plan generation prompt including the natural language description and plan generation instructions; providing the plan generation prompt as input to the LLM, and receiving in response a structured plan comprising a first action and a second action; generating a first segment of workflow definition language corresponding to the first action; generating a second segment of workflow definition language corresponding to the second action; and generating a workflow definition corresponding to the natural language description by combining the first segment of workflow definition language with the second segment of workflow definition language.

In embodiments, the method may comprise deploying the workflow definition to a workflow executor and displaying the automated workflow defined by the workflow definition in an editing user interface associated with the workflow executor.

The natural language description may be a second natural language description and the method may further comprise receiving a first natural language description from a user; generating a rephrasing prompt including the first natural language description and rephrasing instructions; providing the rephrasing prompt as input to the LLM and receiving in response a second natural language description, the second natural language description providing a more detailed description of the automated workflow than the first natural language description.

The method may comprise retrieving a rephrasing shot from a shot data store comprising an example first natural language description and a corresponding example second natural language description, based on a similarity of the example first natural language description to the received first natural language description and including the rephrasing shot in the rephrasing prompt.

The shot data store may comprise a plurality of example first natural language descriptions, and the method may comprise: determining, for each of the plurality of example first natural language descriptions, a similarity between the example first natural language description and the received first natural language description and in response to determining that none of the determined similarities is greater than or equal to a similarity threshold, terminating the method before generating the plan generation prompt.

The method may comprise retrieving a plan generation shot from a shot data store comprising an example natural language description and a corresponding example structured plan, based on a similarity of the example natural language description to the natural language description and including the plan generation shot in the plan generation prompt.

The method may comprise displaying the structured plan on a user interface and receiving user input comprising comments in relation to the structured plan. The method may also comprise generating a corrective plan generation prompt comprising the comments, the structured plan and corrective plan instructions and providing the corrective plan generation prompt as input to the LLM and receiving in response a corrected structured plan based on user the comments.

Generating each segment of workflow definition language may comprise generating a workflow definition prompt including the respective action and workflow definition generation instructions; and providing the workflow definition prompt as input to the LLM and receiving in response the respective segment of workflow definition language.

The method may comprise retrieving a plurality of structured plans from a shot data store that includes an action corresponding in type to the respective action;

determining for each action in each of the retrieved plurality of structured plans, a similarity metric between the action in the retrieved structured plan and the respective action. The similarity metric may be based on the similarity of the action in the retrieved structured plan and the respective action and the similarity metric may be further based on the similarity of the retrieved structured plan and the structured plan received from the LLM. The method may also comprise selecting a plurality of the actions based on the determined similarity metrics; retrieving corresponding segments of workflow definition language from the shot data store for each selected action of the plurality of actions corresponding in type to the respective actions; and including, in the workflow definition prompt, the plurality of actions and corresponding segments of workflow definition language as shots.

The method may comprise validating the respective segment of workflow definition language; in response to the respective segment of workflow definition language failing validation, receiving an error message indicative of reasons for the respective segment failing the validation; generating a segment correction prompt including the error message, the respective segment and validation correction instructions; providing the segment correction prompt to the LLM and receiving in response a corrected segment of workflow definition language.

The method may comprise detecting a trigger action of the workflow from the natural language description and including, in the plan generation prompt, the trigger action.

Detecting the trigger action may comprise generating a trigger detection prompt comprising the natural language description and trigger detection instructions; and providing the trigger detection prompt as input to the LLM and receiving in response the trigger action.

The automated workflow may be a security workflow forming part of a security playbook.

A fifth aspect of the present disclosure provides a computer-implemented method of generating a shot data store for use in generation of automated workflows in workflow definition language from natural language, comprising: receiving a workflow definition in a workflow definition language and a user description of the workflow definition; generating, from the workflow definition, a structured plan comprising a plurality of actions corresponding to the workflow definition; generating, from the structured plan, a natural language description of the workflow definition; storing the workflow definition, the structured plan, the natural language description and the user description in a shot data store.

In embodiments, the method may comprise generating a plan shot generation prompt including the workflow definition and plan generation instructions and providing the plan shot generation prompt to the LLM and receiving the structured plan in response.

The method may comprise generating a natural language shot generation prompt including the structured plan and natural language shot instructions and providing the natural language shot generation prompt to the LLM and receiving the natural language description in response.

The method may comprise generating respective embeddings of the workflow definition, the structured plan, the natural language description and the user description, and storing the generated embeddings in the shot data store.

Further optional features of the fifth aspect are as defined above in relation to the third aspect and may be combined in any combination.

A sixth aspect of the present disclosure provides a computer device configured to interface with a large language model, LLM, comprising: a processor; a memory storing instructions which when executed by the processor cause the device to: generate a plan generation prompt including a natural language description and plan generation instructions; provide the plan generation prompt as input to the LLM, and receiving in response a structured plan comprising a first action and a second action; generate a first segment of workflow definition language corresponding to the first action; generate a second segment of workflow definition language corresponding to the second action; and generate a workflow definition corresponding to the natural language description by combining the first segment of workflow definition language with the second segment of workflow definition language.

In embodiments, the memory storing instructions which when executed by the processor may cause the device to: detect a trigger action of the automated workflow from the natural language description; include, in the plan generation prompt, the trigger action.

The natural language description may be a second natural language description and the memory may store instructions which when executed by the processor may cause the device to: receive a first natural language description from a user; generate a rephrasing prompt including the first natural language description and rephrasing instructions; and provide the rephrasing prompt as input to the LLM and receiving in response a second natural language description, the second natural language description providing a more detailed description of the automated workflow than the first natural language description.

Further optional features of the sixth aspect are as defined in relation to the fourth and fifth aspect and may be combined in any combination.

Reference in any of the aspects defined herein to instructions (e.g. plan generation instructions, rephrasing instructions and so on) included in prompts may refer to instructions, which when processed by the at least one LLM, cause the LLM to generate the specified output. The instructions may be instructions in a textual format, for example in a string, which comprise natural language (e.g. in English) specifying the task to be performed.

According to another aspect of the disclosure there is provided a computer device comprising a processor and a memory, the memory storing instructions, which when executed by the processor, cause the device to carry out any of the methods defined herein.

According to another aspect of the disclosure there is provided a tangible non-transient computer-readable storage medium having recorded thereon instructions which, when executed by a computer device, cause the computer device to perform any of the methods set forth herein.

According to another aspect of the disclosure there is provided a computer program product comprising instructions which, when executed by a computer device, cause the computer device to perform any of the methods set forth herein.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

The invention claimed is:

1. A computer-implemented method of generating workflow definitions in workflow definition language, the method employing a large language model, LLM, the method comprising:
receiving a natural language description of an automated workflow;
generating a plan generation prompt including the natural language description and plan generation instructions;
providing the plan generation prompt as input to the LLM, and receiving in response a structured plan comprising a first action and a second action;
generating a first segment of workflow definition language corresponding to the first action;
generating a second segment of workflow definition language corresponding to the second action; and
generating a workflow definition corresponding to the natural language description by combining the first segment of workflow definition language with the second segment of workflow definition language.

2. The method of claim 1, comprising:
deploying the workflow definition to a workflow executor;
displaying the automated workflow defined by the workflow definition in an editing user interface associated with the workflow executor.

3. The method of claim 1, wherein the natural language description is a second natural language description and the method further comprises:
receiving a first natural language description from a user;
generating a rephrasing prompt including the first natural language description and rephrasing instructions;
providing the rephrasing prompt as input to the LLM and receiving in response a second natural language description, the second natural language description providing a more detailed description of the automated workflow than the first natural language description.

4. The method of claim 3, comprising:
retrieving a rephrasing shot from a shot data store comprising an example first natural language description and a corresponding example second natural language description, based on a similarity of the example first natural language description to the received first natural language description; and
including the rephrasing shot in the rephrasing prompt.

5. The method of claim 4, wherein the shot data store comprises a plurality of example first natural language descriptions, and the method comprises:
determining, for each of the plurality of example first natural language descriptions, a similarity between the example first natural language description and the received first natural language description;
in response to determining that none of the determined similarities is greater than or equal to a similarity threshold, terminating the method before generating the plan generation prompt.

6. The method of claim 1, comprising:
retrieving a plan generation shot from a shot data store comprising an example natural language description and a corresponding example structured plan, based on a similarity of the example natural language description to the natural language description; and
including the plan generation shot in the plan generation prompt.

7. The method of claim 1, comprising:
displaying the structured plan on a user interface;
receiving user input comprising comments in relation to the structured plan;
generating a corrective plan generation prompt comprising the comments, the structured plan and corrective plan instructions; and
providing the corrective plan generation prompt as input to the LLM and receiving in response a corrected structured plan based on user the comments.

8. The method of claim 1, wherein generating each segment of workflow definition language comprises:
generating a workflow definition prompt including the respective action and workflow definition generation instructions; and
providing the workflow definition prompt as input to the LLM and receiving in response the respective segment of workflow definition language.

9. The method of claim 8, comprising:
retrieving a plurality of structured plans from a shot data store that include an action corresponding in type to the respective action;
determining for each action in each of the retrieved plurality of structured plans, a similarity metric between the action in the retrieved structured plan and the respective action, the similarity metric being based on the similarity of the action in the retrieved structured plan and the respective action, the similarity metric being further based on the similarity of the retrieved structured plan and the structured plan received from the LLM;
selecting a plurality of the actions based on the determined similarity metrics;
retrieving corresponding segments of workflow definition language from the shot data store for each selected action of the plurality of actions corresponding in type to the respective actions;
including, in the workflow definition prompt, the plurality of actions and corresponding segments of workflow definition language as shots.

10. The method of claim 8, comprising:
validating the respective segment of workflow definition language;
in response to the respective segment of workflow definition language failing validation, receiving an error message indicative of reasons for the respective segment failing the validation;
generating a segment correction prompt including the error message, the respective segment and validation correction instructions;
providing the segment correction prompt to the LLM and receiving in response a corrected segment of workflow definition language.

11. The method of claim 1, comprising:
detecting a trigger action of the workflow from the natural language description;
including, in the plan generation prompt, the trigger action.

12. The method of claim 11, wherein detecting the trigger action comprises:
generating a trigger detection prompt comprising the natural language description and trigger detection instructions; and
providing the trigger detection prompt as input to the LLM and receiving in response the trigger action.

13. The method of claim 1, wherein the automated workflow is a security workflow forming part of a security playbook.

14. A computer-implemented method of generating a shot data store for use in generation of automated workflows in workflow definition language from natural language, comprising:
receiving a workflow definition in a workflow definition language and a user description of the workflow definition;
generating, from the workflow definition, a structured plan comprising a plurality of actions corresponding to the workflow definition;
generating, from the structured plan, a natural language description of the workflow definition;
storing the workflow definition, the structured plan, the natural language description and the user description in a shot data store.

15. The method of claim 14, comprising:
generating a plan shot generation prompt including the workflow definition and plan generation instructions;
providing the plan shot generation prompt to the LLM and receiving the structured plan in response.

16. The method of claim 15, comprising:
generating respective embeddings of the workflow definition, the structured plan, the natural language description and the user description, and
storing the generated embeddings in the shot data store.

17. The method of claim 14, comprising:
generating a natural language shot generation prompt including the structured plan and natural language shot instructions;
providing the natural language shot generation prompt to the LLM and receiving the natural language description in response.

18. A computer device configured to interface with a large language model, LLM, comprising:
a processor;
a memory storing instructions which when executed by the processor cause the device to:
generate a plan generation prompt including a natural language description and plan generation instructions;
provide the plan generation prompt as input to the LLM, and receiving in response a structured plan comprising a first action and a second action;
generate a first segment of workflow definition language corresponding to the first action;
generate a second segment of workflow definition language corresponding to the second action; and
generate a workflow definition corresponding to the natural language description by combining the first segment of workflow definition language with the second segment of workflow definition language.

19. The device of claim 18, the memory storing instructions which when executed by the processor cause the device to:
detect a trigger action of the automated workflow from the natural language description;
include, in the plan generation prompt, the trigger action.

20. The device of claim 18, wherein the natural language description is a second natural language description and the memory stores instructions which when executed by the processor cause the device to:
receive a first natural language description from a user;
generate a rephrasing prompt including the first natural language description and rephrasing instructions; and
provide the rephrasing prompt as input to the LLM and receiving in response a second natural language description, the second natural language description providing a more detailed description of the automated workflow than the first natural language description.
